(19) United States
(12) Patent Application Publication
(10) Pub. No.: US 2020/0358913 A1
(43) Pub. Date: Nov. 12, 2020

(54) INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Nobuo IWATA, Kanagawa (JP)

(73) Assignee: FUJI XEROX CO., LTD., Tokyo (JP)

(21) Appl. No.: 16/939,147

(22) Filed: Jul. 27, 2020

Related U.S. Application Data
(63) Continuation of application No. 14/532,087, filed on Nov. 4, 2014.

(30) Foreign Application Priority Data
Jun. 11, 2014 (JP) 2014-120881

(51) Int. Cl. H04N 1/00; H04N 1/32; G06Q 10/08

(52) U.S. Cl. CPC H04N 1/00129; H04N 1/00413; H04N 1/00411; H04N 1/00854; H04N 1/00925; H04N 2201/3271; H04N 1/32133; G06Q 10/087; H04N 2201/0094; H04N 2201/0089; H04N 2201/3269; H04N 1/00952

(57) ABSTRACT

Provided an information processing apparatus including a first display unit that displays a first menu screen, which includes a menu item for calling a first function of an information processing apparatus, on a display unit, a second display unit that displays a second menu screen, which includes a menu item for calling a second function for using the information processing apparatus for a specific use, on the display unit, and a control unit that controls which of the first menu screen and the second menu screen is preferentially displayed.

### CROSS-REFERENCE TO RELATED APPLICATIONS

This is a Continuation of application Ser. No. 14/532,087 filed Nov. 4, 2014, which in turn claims priority under 35 USC 119 from Japanese Patent Application No. 2014-120881 filed Jun. 11, 2014.

### BACKGROUND

### (i) Technical Field

The present invention relates to an information processing apparatus, and a non-transitory computer readable medium.

### (ii) Related Art

A system in which publications such as books and magazines are managed by a computer is known.

### SUMMARY

According to an aspect of the invention, there is provided an information processing apparatus including:

a first display unit that displays a first menu screen, which includes a menu item for calling a first function of an information processing apparatus, on a display unit;

a second display unit that displays a second menu screen, which includes a menu item for calling a second function for using the information processing apparatus for a specific use, on the display unit; and

a control unit that controls which of the first menu screen and the second menu screen is preferentially displayed.

### BRIEF DESCRIPTION OF THE DRAWINGS

Exemplary embodiments of the present invention will be described in detail based on the following figures, wherein:

FIG. 1 is a block diagram illustrating the configuration of an information processing system according to a first exemplary embodiment of the invention;

FIG. 2 is a block diagram illustrating the configuration of an image processing apparatus according to the first exemplary embodiment;

FIG. 3 is a block diagram illustrating the configuration of a server device according to the first exemplary embodiment;

FIG. 4 is a diagram illustrating an example of data stored in the server device;

FIG. 5 is a diagram illustrating an exterior of a book;

FIG. 6 is a diagram illustrating exteriors of a magazine and a user card;

FIG. 7 is a diagram illustrating a functional configuration of the image processing apparatus;

FIGS. 8A and 8B are diagrams illustrating examples of a standard function menu screen and an authentication screen, respectively;

FIG. 9 is a flow chart illustrating operations, which are performed by the image processing apparatus, after an additional application is installed;

FIG. 10 is a diagram illustrating a configuration example of an additional function setting file;

FIG. 11 is a diagram illustrating an example of a book menu screen;

FIGS. 12A and 12B are diagrams illustrating an example of a menu screen after links are set;

FIG. 13 is a flow chart illustrating a setting operation of a top screen which is performed by the image processing apparatus;

FIG. 14 is a flow chart illustrating a basic operation related to a menu screen which is performed by the image processing apparatus;

FIG. 15 is a flow diagram illustrating a book management operation of the server device;

FIG. 16 is a flow diagram illustrating operations of the server device when registering a database;

FIG. 17 is a flow diagram illustrating operations of the server device when lending a publication;

FIG. 18 is a diagram illustrating an example of a screen displayed on the image processing apparatus;

FIG. 19 is a diagram illustrating an example of a screen displayed on the image processing apparatus;

FIG. 20 is a diagram illustrating an example of a screen displayed on the image processing apparatus;

FIG. 21 is a flowchart illustrating a display operation of an operation screen which is performed by the image processing apparatus;

FIGS. 22A and 22B are diagrams illustrating an example of an operation screen displayed by the image processing apparatus;

FIG. 23 is a flow chart illustrating operations, which are performed by an image processing apparatus according to a second exemplary embodiment of the invention, after an additional application is installed;

FIGS. 24A and 24B are diagrams illustrating configuration examples of an additional function setting file and a menu setting file, respectively;

FIGS. 25A and 25B are diagrams illustrating examples of a book service screen and a librarian function screen, respectively;

FIGS. 26A and 26B are diagrams illustrating an example of a menu screen after links are set; and

FIG. 27 is a diagram illustrating another display example of a menu screen.

### DETAILED DESCRIPTION

### First Exemplary Embodiment

Configuration

Hereinafter, exemplary embodiments of the invention will be described.

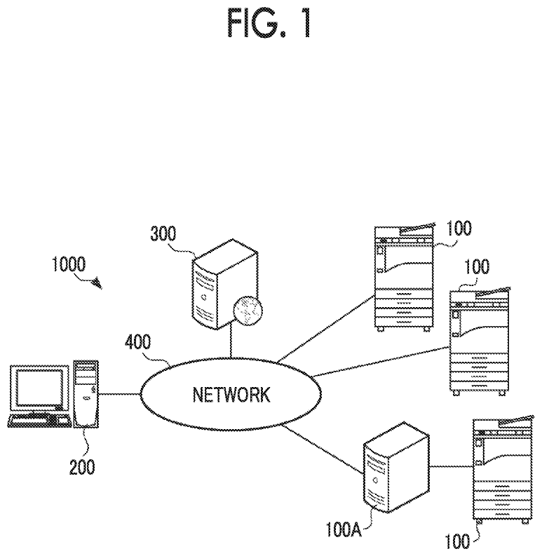

FIG. 1 is a block diagram illustrating the entire configuration of an information processing system 1000 according to an exemplary embodiment of the invention. The information processing system 1000 is a system for managing publications. Publications are roughly classified into books and magazines. A book is a published single complete publication written by one person or plural persons or editors, and includes a corpus, a compendium, and the like which are published in series. On the other hand, a magazine is a publication continuously published on a regular basis under the same title, and is given a volume (series), a volume number, a part, a copy number, and the like. International standard book numbers of an ISBN (for example, ten digits or thirteen digits) and an ISSN (for example, eight digits or thirteen digits) are given to the books and the magazines, respectively.

The information processing system 1000 includes an image processing apparatus 100, a server device 200, and a bibliographic information storage device 300. The image processing apparatus is installed in, for example, a library, a small library, or a library space (hereinafter, collectively referred to as “library”). The server device is operated, for example, by a library manager. The bibliographic information storage device is managed, for example, by an operator of the National Diet Library or a bibliographic information providing site. The image processing apparatus 100, the server device 200, and the bibliographic information storage device 300 are connected to a network 400. The image processing apparatus 100 is an example of an information processing apparatus of the invention, and is an image forming apparatus that has plural functions including an image reading function and an image formation function. The server device 200 executes a process for realizing functions of managing publications by analyzing an image read by the image processing apparatus 100, acquiring bibliographic information from the bibliographic information storage device 300, and the like. The bibliographic information storage device 300 is a web server device that stores bibliographic information of a very large number of publications and provides the bibliographic information via the network 400. The network 400 includes various types of communication lines such as a local area network (LAN), an intranet, a virtual private network (VPN), the Internet, and a telephone line. The numbers of image processing apparatuses 100, server devices 200, and bibliographic information storage devices 300 are not limited to those illustrated in FIG. 1.

Meanwhile, the functions of the server device 200 may be incorporated in the image processing apparatus 100, or may be incorporated in a terminal device 100A connected to any one image processing apparatus 100 as a front-end device. In addition, the functions of the server device 200 may be distributed to plural server devices, and the server devices may cooperate to realize the same functions as those of the server device 200. The functions of the server device 200 may be provided as a so-called cloud service. In addition, the configurations (the image processing apparatus 100, the server device 200, and the terminal device 100A) other than the bibliographic information storage device 300 may be packaged in one device.

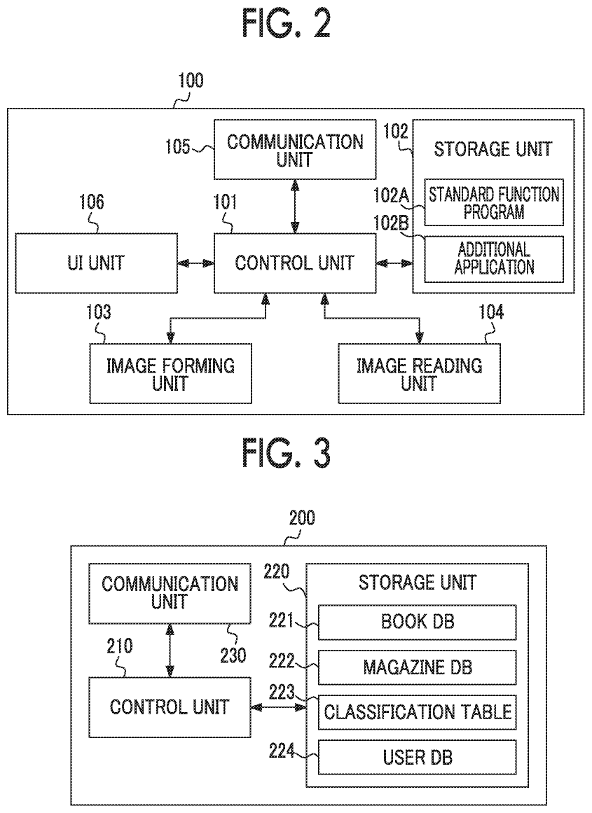

FIG. 2 is a block diagram illustrating the configuration of the image processing apparatus 100. The image processing apparatus 100 is an information processing apparatus including a control unit 101, a storage unit 102, an image forming unit 103, an image reading unit 104, a communication unit 105, and a user interface (UI) unit 106.

The control unit 101 is a unit that controls units of the image processing apparatus 100, and is constituted by a control circuit such as, for example, an application specific integrated circuit (ASIC) or a central processing unit (CPU) and various types of memories. The storage unit 102 is a storage unit such as, for example, a hard disk, and stores programs executed by the CPU and data used in association with the execution of the programs.

The storage unit 102 stores a web browser, which realizes a function of displaying a web page, as an operating system (OS) and as a program operating on the OS, a standard function program 102A, and an additional application 102B. The standard function program 102A is a program for executing a standard function incorporated in advance in the image processing apparatus 100. The standard function program 102A is a program installed, for example, in a manufacturing step of the image processing apparatus 100. The standard function of this exemplary embodiment is an example of a first function of the invention which is included in the information processing apparatus. The standard function is a function which is normally incorporated in the image processing apparatus 100, and is a function for using the image processing apparatus 100 for a normal use. Herein, the normal use refers to using of functions such as a copying function, a scanning function, a printing function, and a facsimile function, which are included in a multi-function printer having a configuration of the related art, for usual uses such as copying, scanning, printing, and facsimile use. In addition, the standard function program 102A realizes functions for performing screen control of displaying a screen regarding the standard function.

The additional application 102B is an application program realizing an additional function (an example of a second function of the invention) which is additionally added to the image processing apparatus 100. The additional application 102B is a program installed, for example, by a library manager. The additional function of this exemplary embodiment is an example of the second function of the invention which is included in the information processing apparatus. The additional function is a function for using the image processing apparatus 100 for a specific use. Here, using for a specific use refers to using of the functions of the image processing apparatus 100 for a use for accomplishing a specific purpose. As an example, the additional function of this exemplary embodiment is used to use the image processing apparatus 100 for managing publications by using the image reading unit 104 and the like which are included in the image processing apparatus 100. The function regarding the management of publications (hereinafter, referred to as “book management”) is a function regarding the management of publications (literature) which are placed in a library. Specifically, the function includes a function of registering publications in a database within the server device 200 (hereinafter, referred to as a “registration function”), a function of updating the database in order to lend a publication (hereinafter, referred to as a “lending function”), a function of updating the database in order to return the lent publication (hereinafter, referred to as a “return function”), and a function of copying a publication (hereinafter, referred to as a “literature copying function”). In addition, the additional application 102B realizes a function for performing screen control of displaying a screen regarding the additional function.

The image forming unit 103 is a unit that forms an image on a medium using, for example, an electrophotographic system. The image forming unit irradiates an image holder such as a photoreceptor with a laser beam to form a latent image, develops the latent image using toners of yellow (Y), magenta (M), cyan (C), and black (K) colors, transfers the developed images to a medium such as a recording sheet, performs a fixing process thereon, and discharges the medium. The image reading unit 104 is a unit that optically reads an image on a document placed on a platen to generate image data. The communication unit 105, which is a unit that transmits and receives data, communicates with the server device 200 through the network 400. The UI unit 106, which is a unit realizing interaction with a user, includes an operation unit that receives a user's operation and a display unit that displays an image (screen) in a display region. The operation unit includes an operation element such as, for example, a physical key and a touch sensor (for example, a resistance film type or an electrostatic capacitance type) and supplies an operation signal based on the user's operation to the control unit 101. The display unit includes, for example, a liquid crystal panel and a liquid crystal driving circuit, and displays an image under the control of the control unit 101.

FIG. 3 is a block diagram illustrating a hardware configuration of the server device 200. The server device 200 includes a control unit 210, a storage unit 220, and a communication unit 230. The control unit 210 is a unit that controls operations of the respective units of the server device 200. The control unit 210 is constituted by a control circuit such as a CPU and various types of memories, and controls the operations of the respective units of the server device 200 by executing a program. The storage unit 220 is a unit that stores data used in the server device 200. The storage unit 220 is, for example, a hard disk, and stores the program executed by the control unit 210 and data used in association with the execution of the program. Herein, the storage unit 220 stores a book database (DB) 221, a magazine DB 222, a classification table 223, and a user DB 224. The communication unit 230, which is a unit transmitting and receiving data, communicates with the image processing apparatus 100 and the bibliographic information storage device 300 through the network 400.

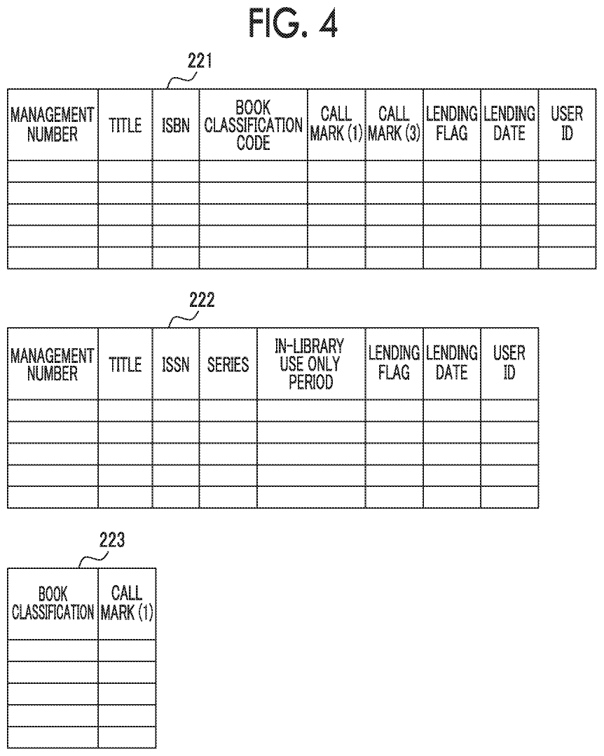

FIG. 4 is a diagram illustrating a part of the contents of the book DB 221, the magazine DB 222, and the classification table 223 which are stored in the server device 200. In the book DB 221, a management number is identification information for identifying each of books possessed by a library. A title is a title of a book. When there are plural books having the same title, the books are given different management numbers. Here, an ISBN is an international standard book number given to a book. A book classification code is a standard classification based on the theme and contents of a book, and there is a classification method called Nippon decimal classification (NDC9) in Japan. A call number (1) is classification of a book which is used in each library. The above-described Nippon decimal classification and classification which is uniquely determined by a library are used as the call number (1). In general, a library determines arrangement locations and an alignment order of books in bookshelves for each classification, and thus arrangement locations and an alignment order of books in bookshelves in a library are specified by the call number (1). A call number (3) is a serial number within the call number (1). In general, the same number is given in a case of the same title. A lending flag is a flag indicating whether or not a book is in a lent state. A lending date is a lending date in a case where a book is in a lent state. A user ID is identification information of a user who has borrowed a book in a case where the book is in a lent state.

Each piece of data included in the magazine DB 222 may be understood by replacing “book” in the book DB 221 described above with “magazine”.

Meanwhile, the magazine DB 222 includes an in-library use only period which is a period from the publication date of the magazine in which lending is prohibited.

The classification table 223 shows a correspondence relation between the book classification code which is a standard classification of books and the call number (1) which is a unique classification of books of a library. A standard book classification code such as NDC9 is converted to the call number (1) used in the library, based on the classification table. Although not illustrated in the drawing, the user DB 224 is a database including user IDs allocated to users, attributes of the users, and the like.

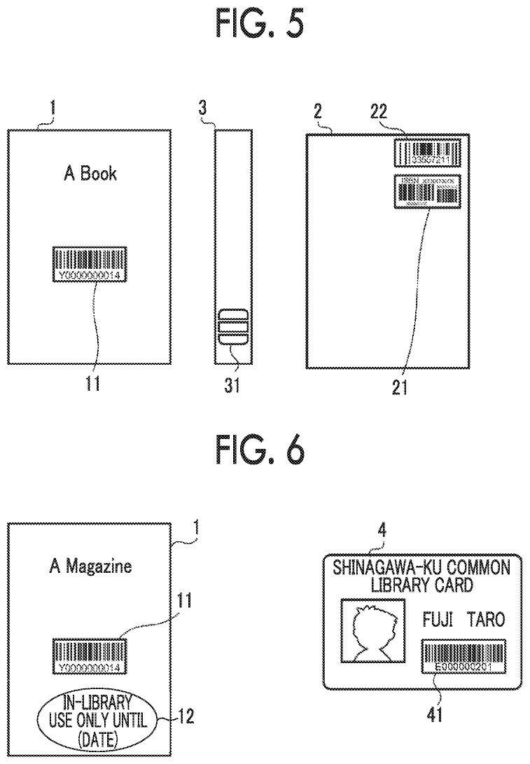

FIG. 5 is a plan view illustrating an example of an exterior of a publication. In the example of FIG. 5, a management bar code 11 indicating a management number is attached to a front cover 1 of the publication. As described above, the management bar code 11 is identification information capable of identifying each publication. Further, a configuration may be adopted in which a book and a magazine may be identified based on the management number by using an identifier of “YB” representing a book and an identifier of “YM” representing a magazine as apart of the management number, that is, using a management number of, for example, “YB000123” in a case of a book and using a management number of, for example, “YM0000123” in a case of a magazine. In this example, the management bar code 11 is attached to the front cover 1, but may be attached to a back cover 2 or a spine cover 3.

An ISBN bar code 21 representing an ISBN (in a case of a book) which is given to a publication or an ISSN bar code 21 representing an ISSN (in a case of a magazine) and a price bar code 22 indicating the price of the publication are printed on or attached to the back cover 2 of the publication. A label 31 is attached to the spine cover 3. The label is displayed in a three-stage configuration. The call number (1) is written in the uppermost stage thereof, and the call number (3) is written in the lowermost stage thereof.

In a case of a magazine, an in-library use only label 12 is attached to the front cover 1 and the like of the magazine (see FIG. 6). A publication is lent for only users carrying a user card 4 illustrated in FIG. 6. A user ID bar code 41 indicating a user ID for identifying each user is printed on or attached to the user card 4.

Meanwhile, a form for expressing various pieces of information described above is not required to be a bar code, and may be a code in which each piece of information is encoded. The code is a system of symbols or signs for expressing information. In this exemplary embodiment, the code includes a call number in addition to various types of bar codes or QR codes (registered trademark). In addition, the code attached to a publication includes a code and the like attached to the publication in a removable form, in addition to a code printed on the publication and a code attached to the publication.

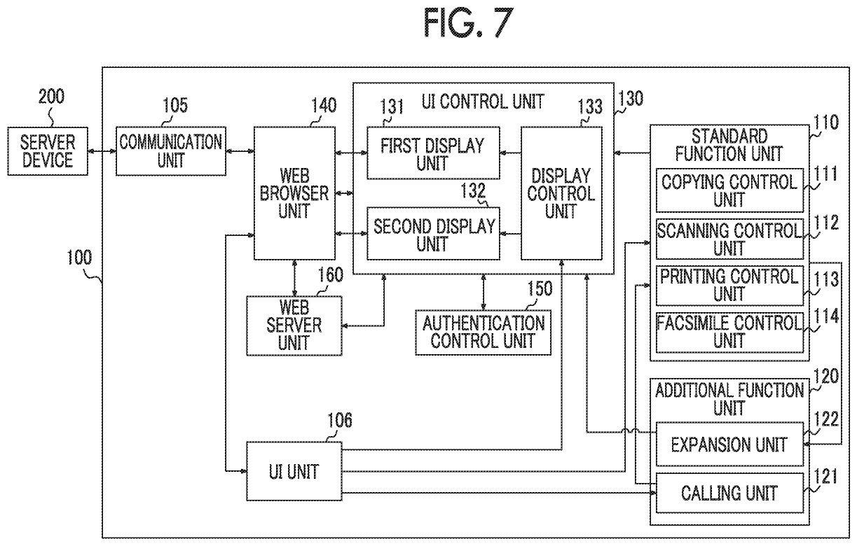

FIG. 7 is a diagram illustrating a functional configuration of the image processing apparatus 100. The functions of the image processing apparatus 100 are roughly classified into a standard function unit 110, an additional function unit 120, a UI control unit 130, a web browser unit 140, an authentication control unit 150, and a web server unit 160. The standard function unit 110 is realized by the standard function program 102A. The additional function unit 120, the UI control unit 130, the authentication control unit 150, and the web server unit 160 are realized by the additional application 102B. The web browser unit 140 is realized by a web browser.

The standard function unit 110 includes a copying control unit 111 that calls a copying function, a scanning control unit 112 that calls a scanning function, a printing control unit 113 that calls a printing function, and a facsimile control unit 114 that calls a facsimile function. The copying control unit 111 causes the image reading unit 104 to read an image on a document to generate image data and causes the image forming unit 103 to form an image based on the generated image data. The scanning control unit 112 causes the image reading unit 104 to read an image on a document to generate image data and causes the storage unit 102 to store the generated image data. The printing control unit 113 causes the image forming unit 103 to form an image based on image data received by the communication unit 105 from the network 400. The facsimile control unit 114 performs facsimile transmission and facsimile reception. The facsimile transmission is a process of causing the image reading unit 104 to read an image on a document to generate image data and transmitting the generated image data through a telephone line of the network 400. The facsimile reception is a process of causing the image forming unit 103 to form an image based on the image data received by the communication unit 105 from the telephone line of the network 400.

The additional function unit 120 includes a calling unit 121 and an expansion unit 122. The calling unit 121 is an example of a unit that calls an additional function of the image processing apparatus 100. As described above, the additional function is a function regarding publication management, and includes a registration function, a lending function, a return function, and a literature copying function. Among the functions, the literature copying function is a function accompanied by the calling of a copying function which is a standard function, which will be described later in detail. The expansion unit 122 is an example of a unit that expands a standard function called in association with an additional function. Herein, the expansion unit 122 is realized by a plug-in for the additional application 102B. However, the expansion unit 122 may be realized by the function of the additional application 102B. The expansion unit 122 may activate a function which is a partial function of the standard function program 102A and which is not used in a standard function and thus is inactivated.

The UI control unit 130 performs control regarding interaction with a user through the UI unit 106. In detail, the UI control unit 130 includes a first display unit 131, a second display unit 132, and a display control unit 133. The first display unit 131 is an example of a unit that displays a first menu screen including a menu item for calling a standard function on the UI unit 106. The menu item of this exemplary embodiment is a menu (item) by which an operation selected by a user is performed. The second display unit 132 is an example of a unit that displays a second menu screen including a menu item for calling an additional function on the UI unit 106. The calling unit 121 described above is operated (started), for example, when the menu item of the second menu screen is selected, and calls an additional function corresponding to the selected menu item. The first display unit 131 and the second display unit 132 supply, for example, screen data in a hyper text markup language (HTML) format to the web browser unit 140 and display a menu screen on which the screen data is shown. The display control unit 133 is an example of a control unit that controls which of the first menu screen and the second menu screen to display preferentially.

Screen data regarding a standard function is supplied to the UI control unit 130 from the standard function unit 110, and screen data regarding an additional function is supplied to the UI control unit 130 from the additional function unit 120, but the invention is not limited thereto. The standard function unit 110 and the additional function unit 120 may supply data to the web server unit 160, and the web server unit 160 may analyze the data to generate screen data and may supply the generated screen data to the UI control unit 130.

Further, the UI control unit 130 supplies data of a web page which is received from the server device 200 through the communication unit 105 to the web browser unit 140 and displays a screen on the UI unit 106. In addition, the UI control unit 130 receives an operation performed on the UI unit 106 by a user, and performs screen control of displaying a screen based on the received operation.

The web browser unit 140 displays a screen on the UI unit 106 based on the screen data supplied from the UI control unit 130 (for example, the first display unit 131 and the second display unit 132). The web browser unit 140 displays a screen on the UI unit 106, for example, through the entire screen or a window. The web browser unit 140 displays a screen based on screen data in an HTML format or screen data including cascading style sheets (CSS), JavaScript (registered trademark), image data, document data (document data in a portable document format (PDF)) and the like.

The authentication control unit 150 performs control of authenticating a user. The authentication of a user is performed in order to determine whether or not a function incorporated in the image processing apparatus 100 is usable. The authentication of a librarian as a user providing a registration function is an example of the authentication. The UI control unit 130 displays an authentication screen (login screen) for authenticating a user on the UI unit 106 or receives a user's operation regarding the authentication by using the UI unit 106, under the control of the authentication control unit 150.

The web server unit 160 converts data supplied from the web browser unit 140 into a request message for requesting control for the standard function unit 110 and the additional function unit 120 and supplies the request message to the standard function unit 110 and the additional function unit 120.

Meanwhile, one or more of the standard function unit 110, the additional function unit 120, the UI control unit 130, the web browser unit 140, and the authentication control unit 150 may be incorporated in the web server unit 160.

Meanwhile, the web server unit 160 may be omitted in the image processing apparatus 100.

Operation

Next, the operation of the image processing apparatus 100 will be described.

A: Display Operation of Screen Regarding Standard Function

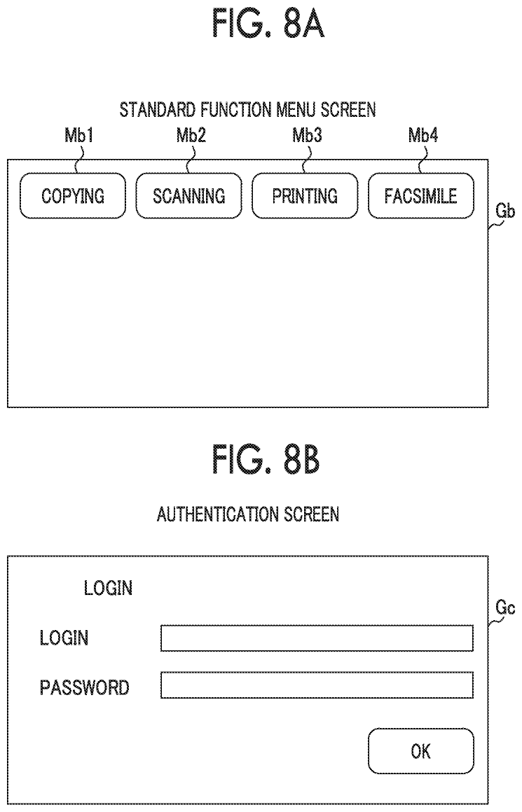

First, a display operation of a screen regarding a standard function will be described. The control unit 101 of the image processing apparatus 100 executes the standard function program 102A to display a standard function menu screen Gb (an example of the first menu screen) illustrated in FIG. 8A on the UI unit 106. As illustrated in FIG. 8A, the standard function menu screen Gb includes a menu item Mb1 corresponding to a copying function, a menu item Mb2 corresponding to a scanning function, a menu item Mb3 corresponding to a printing function, and a menu item Mb4 corresponding to a facsimile function.

B: Display Operation of Authentication Screen Next, a display operation of an authentication screen will be described. When a user is restricted from being provided with a function incorporated in the image processing apparatus 100, the control unit 101 performs user authentication before providing the function to the user. The control unit 101 authenticates whether or not a user is a librarian, with respect to a registration function. When the control unit 101 performs user authentication, the control unit displays an authentication screen Gc illustrated in FIG. 8B on the UI unit 106. In the authentication screen Gc, an input box corresponding to an “ID” as an identifier for identifying a user, an input box for inputting a password for authentication, and a soft button (hereinafter, referred to as an “OK button”) which is written as “OK” for instructing performing user authentication are disposed. When the authentication succeeds, the control unit 101 executes a process for realizing a function to be provided to the authenticated user.

Meanwhile, the authentication screen Gc is displayed, for example, by the function of the additional application 102B, but may be displayed by the function of the standard function program 102A.

C: Display Operation of Screen Regarding Additional Function

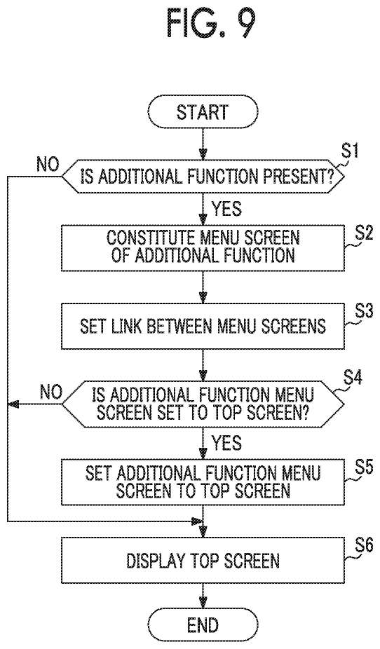

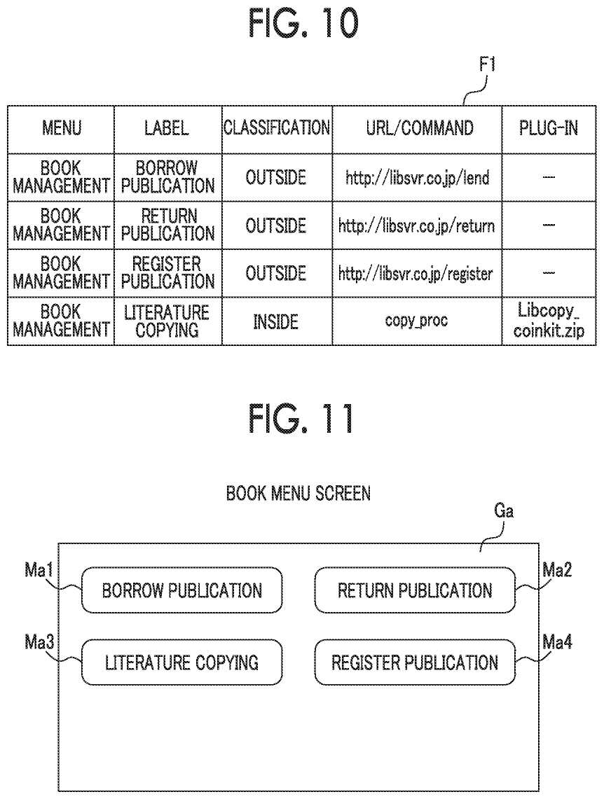

FIG. 9 is a flowchart illustrating the operation of the image processing apparatus 100 including the additional application 102B. FIG. 10 is a diagram illustrating a configuration example of an additional function setting file used to display a menu screen corresponding to an additional function.

When a top screen is displayed, the control unit 101 of the image processing apparatus 100 determines whether or not an additional function is present (step S1). Here, the top screen refers to a screen for receiving a first instruction regarding a function when the image processing apparatus 100 is powered on, is reset, and the like. When the control unit 101 determines that an additional function is present (step S1; Yes), a menu screen of the additional function is constituted (step S2). Herein, the control unit 101 constitutes a book menu screen by using an additional function setting file F1 (see FIG. 10) which is acquired based on the additional application 102B.

As illustrated in FIG. 10, the additional function setting file F1 is a file in which a label, a classification, a uniform resource locator (URL)/command, and a plug-in are associated with a menu item corresponding to an additional function. Herein, the menu item corresponding to the additional function indicates an attribute of “book management” representing that the menu item is a menu item corresponding to book management. The label is a character string for identifying each of menu items corresponding to the additional function, and is a character string indicating a menu item name (item name) herein. The classification indicates classification of the calling of an additional function (calling method), and is either “inside” or “outside” herein. Here, “inside” means that a predetermined command is executed when a menu item is selected to thereby call a function inside the image processing apparatus 100. In this case, a command (“copy_proc” in a case of a literature copying function) to be executed for the calling of an additional function is designated in the additional function setting file F1. “Outside” means that a function is called from an external device by using a web browser when a menu item is selected. In this case, a URL (herein, a URL of the server device 200) which is used to call an additional function is designated in the additional function setting file F1. The plug-in indicates a plug-in for expanding a standard function when an additional function is accompanied by the calling of the standard function. Herein, a plug-in of “Libcopy_coinkit_zip” is associated with the literature copying function.

When the additional function setting file F1 illustrated in FIG. 10 is used, a book menu screen Ga (an example of the second menu screen) illustrated in FIG. 11 is constituted. As illustrated in FIG. 11, a menu item Ma1 corresponding to a lending function and written as “borrow a publication”, a menu item Ma2 corresponding to a return function and written as “return a publication”, a menu item Ma3 corresponding to a literature copying function” and written as “literature copying”, and a menu item Ma4 corresponding to a registration function and written as “register a publication” are disposed in the book menu screen Ga. The URL designated in the additional function setting file F1 is associated with each of the menu items Ma1, Ma2, and Ma4, for example, by an HTML FORM tag. When a user selects a menu associated with a URL, the control unit 101 of the image processing apparatus 100 transmits a hyper text transfer protocol (HTTP) request to the URL associated with the selected menu item. On the other hand, when the menu item Ma3 associated with a command is selected, the control unit 101 executes the command designated in the additional function setting file F1.

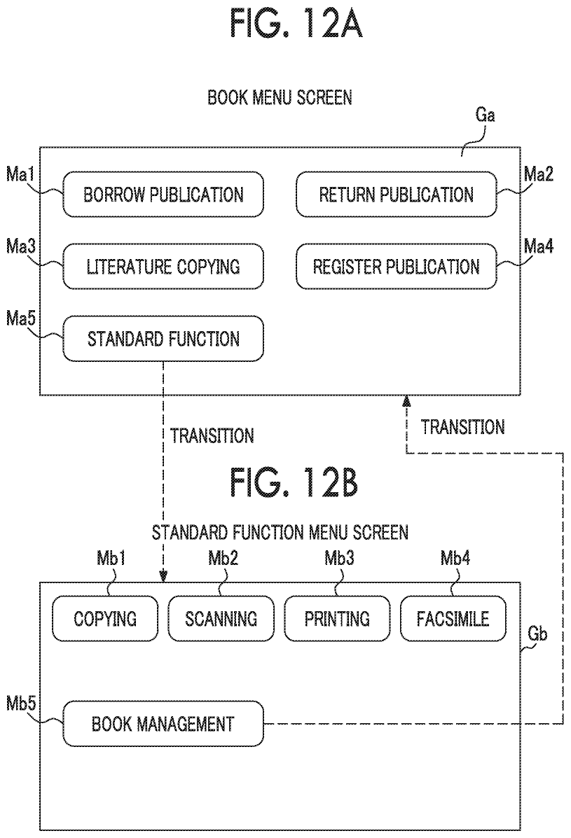

Next, the control unit 101 sets a link (hyperlink) between menu screens (step S3). As illustrated in FIG. 12A, the control unit 101 disposes a menu item Ma5, which is associated with a URL for transitioning to the standard function menu screen Gb, in the book menu screen Ga. In addition, as illustrated in FIG. 12B, the control unit 101 disposes a menu item Mb5, which is associated with a URL for transitioning to the book menu screen Ga, in the standard function menu screen Gb.

Meanwhile, display elements (display parts such as a soft button) and information specifying display modes such as the size, color, character font, arrangement order, and arrangement positions of the display elements may be included in the additional function setting file F1.

Next, the control unit 101 determines whether or not to set an additional function menu screen (herein, the book menu screen Ga) to a top screen (step S4). When the control unit 101 determines that the additional function menu screen is not to be set to a top screen (step S4; No), the control unit displays a current top screen (step S6). For example, when a top screen is designated by a manager of the image processing apparatus 100, the control unit 101 displays the top screen based on the designation. On the other hand, when the control unit 101 determines that the additional function menu screen is to be set to a top screen (step S4; Yes), the control unit sets the additional function menu screen to a top screen (step S5) and displays the set top screen (step S6). Here, the storage unit 102 stores information indicating which menu screen is set to a top screen for the determination of step S4.

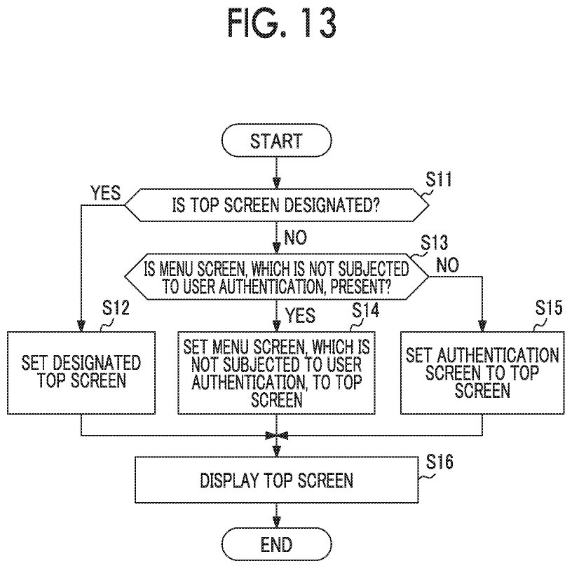

The image processing apparatus 100 may set a top screen in accordance with a procedure of a flow chart illustrated in FIG. 13. The following processes are executed in place of the processes of step S4 to S6 described in FIG. 9.

When a top screen is displayed, the control unit 101 determines whether or not a top screen is designated (step S11). When the control unit 101 determines that a top screen is designated (step S11; Yes), the control unit sets the designated screen to a top screen (step S12). When the control unit 101 determines that a top screen is not designated (step S11; No), the control unit determines whether or not a menu screen, which is not subjected to user authentication, is included in the additional function menu screen (step S13). The menu screen, which is not subjected to user authentication, is a screen including a menu item corresponding to a function which is provided to the user without performing user authentication. Herein, the book menu Ga is shown as an example of the menu screen, which is not subjected to user authentication. The book menu screen Ga is a screen including menu items corresponding to a lending function, a return function, and a literature copying function which are provided to the user without performing user authentication.

Accordingly, the determination result is “Yes” in step S13, and thus the control unit 101 sets the book menu screen Ga (FIG. 12A) to a top screen (step S14). When a menu screen, which is not subjected to user authentication, is not present (step S13; No), the control unit 101 sets the authentication screen Gc to a top screen (step S15). In this case, the control unit 101 succeeds in user authentication using the authentication screen Gc and then displays a menu screen matched to the user's role (for example, a librarian). Then, the control unit 101 displays the top screen set in step S12, step S14, or step S15 on the UI unit 106 (step S16).

D: Basic Operation Regarding Menu Screen

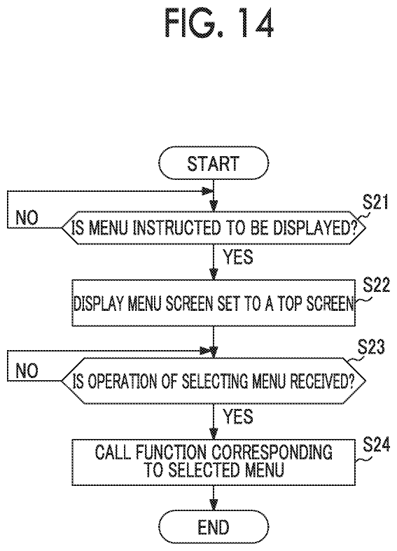

Hereinafter, a basic operation from the displaying of a menu screen in the image processing apparatus 100 to the calling of a function will be described with reference to a flow chart illustrated in FIG. 14.

The control unit 101 of the image processing apparatus 100 determines whether or not a menu item is instructed to be displayed (step S21). The menu item is instructed to be displayed, for example, by a user's operation for displaying a top screen, that is, the occurrence of an operation event, but may be instructed to be displayed by the occurrence of other specific events.

When the determination result is “Yes” in step S21, the control unit 101 displays the menu screen set to a top screen in accordance with the procedure of the flowchart illustrated in FIG. 9 or FIG. 13, for example, on the entire screen of the UI unit 106 (step S22). The displaying of the menu screen as a top screen is an example of “preferentially displaying” in the invention. Next, the control unit 101 determines whether or not an operation of selecting a menu item included in the displayed menu screen has been received (step S23). The control unit 101 receives an operation of selecting a menu item, for example, by an operation of bringing a finger into contact with a display position of the menu item in the UI unit 106 or an operation of making a decision by superimposing a cursor on the menu item using an operation element. When the determination result is “Yes” in step S23, the control unit 101 calls a function corresponding to the selected menu item (step S24). Then, the control unit 101 displays a screen regarding the called function on the UI unit 106 or executes a process for realizing the function. When user authentication is performed, the control unit 101 performs the user authentication before calling the function.

In addition, when the control unit 101 receives an operation of selecting the menu item Ma5 of the book menu screen Ga, the control unit displays the standard function menu screen Gb on the UI unit 106. When the control unit receives an operation of selecting the menu item Mb5 of the standard function menu screen Gb, the control unit displays the book menu screen Ga on the UI unit.

E: Book Management Operation

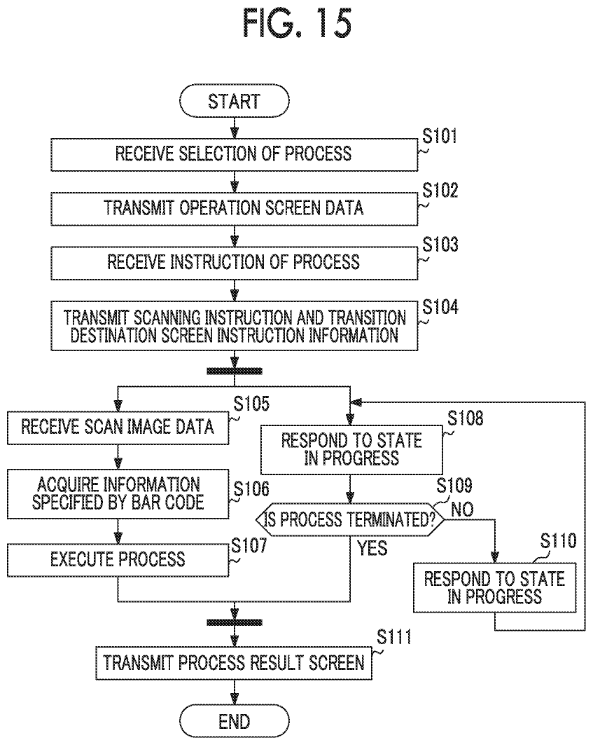

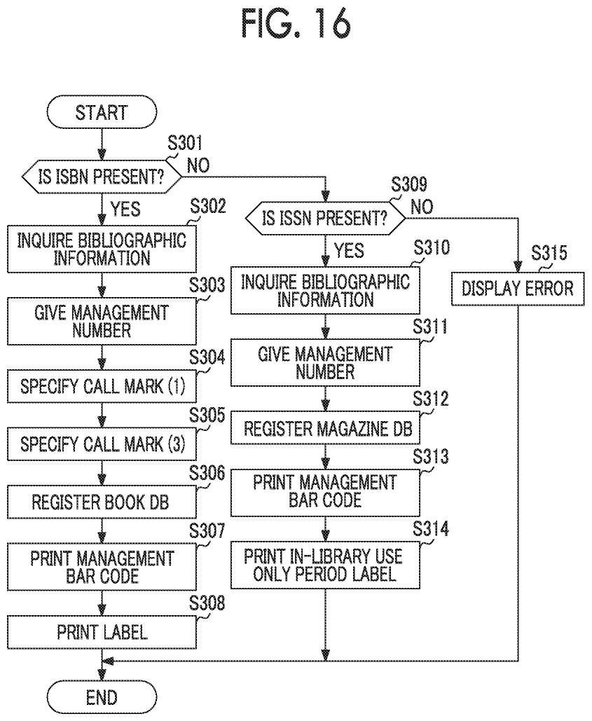

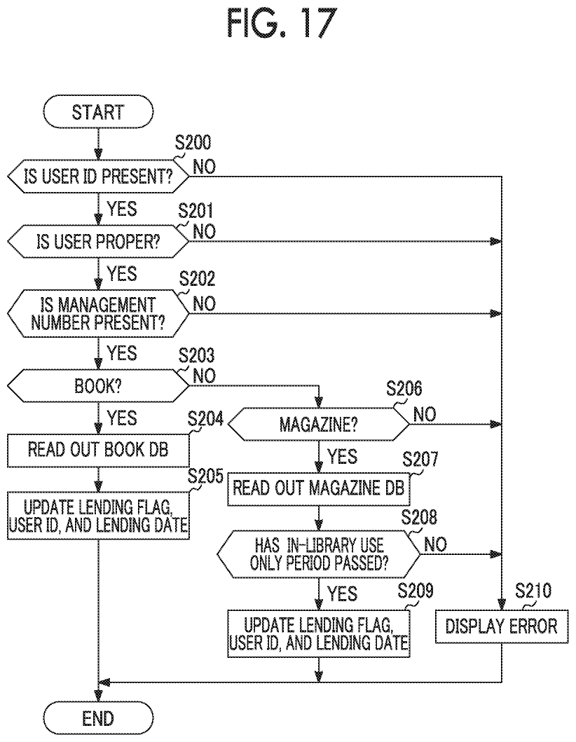

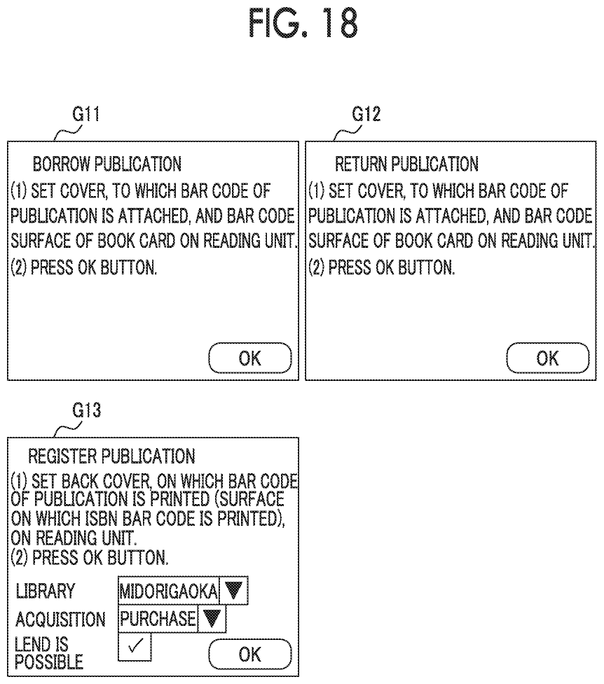

FIGS. 15 to 17 are flow charts illustrating a book management operation of the server device 200. FIGS. 18 to 20 are diagrams illustrating an example of a screen displayed on the image processing apparatus 100. FIG. 15 illustrates a basic operation of the server device 200, and FIGS. 16 and 17 show a detailed process of step S107 of FIG. 15.

E-1: Basic Operation

First, it is assumed that the book menu screen Ga, illustrated in FIG. 12A, which is set to a top screen is displayed on the UI unit 106 of the image processing apparatus 100. When another menu screen is set to a top screen in step S5, the book menu screen Ga is displayed after a user's operation is performed.

Hereinafter, a description will be given of an operation in a case where a user selects any one of the menu item Ma1 corresponding to a lending function, the menu item Ma2 corresponding to a return function, and the menu item Ma4 corresponding to a registration function, in the image processing apparatus 100. The control unit 101 of the image processing apparatus 100 transmits an HTTP request to a URL associated with the selected menu item. The control unit 210 of the server device 200 receives the HTTP request to thereby receive a selection of a function (step S101 of FIG. 15). Then, the control unit 210 reads out operation screen data according to the HTTP request from the storage unit 220 and transmits the operation screen data to the image processing apparatus 100 (step S102).

Meanwhile, with regard to a function which is subjected to user authentication, the control unit 210 transmits operation screen data corresponding to the function to the image processing apparatus 100 on condition that the user authentication using the authentication screen Gc described in FIG. 8B has succeeded.

The control unit 101 of the image processing apparatus 100 displays an operation screen based on the received operation screen data on the UI unit 106. For example, when a library registers a publication which is newly obtained, a registration screen G13 (FIG. 18) is displayed on the UI unit 106. When a library lends a publication (a user borrows a publication), a lending process screen G11 (FIG. 18) is displayed on the UI unit 106. When a user returns a publication, a return process screen G12 (FIG. 18) is displayed on the UI unit 106. When a publication is registered, a librarian sets the back cover 2 of the publication having the ISBN bar code 21 printed thereon in the image reading unit 104 of the image processing apparatus 100, inputs necessary information in an input box provided in the registration screen G13, and selects an OK button. Thus, an identifier of the OK button, the value information thereof, and information input in the input box are transmitted to a URL associated by an HTML FORM tag in the registration screen. In addition, when a publication is lent or returned, a user sets the front cover 1 of the publication having the management bar code 11 attached thereto and a surface of his or her user card 4 having a user ID bar code printed thereon on a platen glass included in the image reading unit 104 of the image processing apparatus 100, and selects an OK button in the lending process screen G11 or the return process screen G12. Thus, the image reading unit 104 reads plural codes through one scanning from one publication on the platen glass. At this time, the image reading unit 104 may simultaneously read codes through one scanning from plural publications on the platen glass, and may match a user card on the platen glass and read a code from the user card. An identifier of an OK button and the value information thereof are transmitted to a URL associated by an HTML FORM tag in the screens. The control unit 210 of the server device 200 receives the pieces of information, and thus receives an instruction of a process (step S103). Meanwhile, a hard button of the image processing apparatus 100 may receive the same instruction as in a soft button.

The control unit 210 of the server device 200 transmits a scanning instruction and transition destination screen designation information to the image processing apparatus 100 (step S104). The scanning instruction includes parameters at the time of scanning, such as a scanning resolution (for example, 300 dpi (dots/inch)), black and white, and an image format (for example, a tagged image file format (TIFF) format), and a URL indicating a transmission destination of scanned image data. The transition destination screen designation information is path information such as a URL which means a storage destination of screen data.

The control unit 101 of the image processing apparatus 100 reads an image using the image reading unit 104 in response to the received scanning instruction, and generates image data based on parameters designated from the server device 200. The control unit 101 transmits the generated image data to the designated transmission destination. The control unit 101 adds not only the parameters at the time of scanning but also meta information (information of an authenticated user, an address of the image processing apparatus 100, and the like) to the scanned image data when necessary.

The control unit 210 of the server device 200 receives the scanned image data transmitted from the image processing apparatus 100 (step S105). Then, the control unit 210 acquires information which is specified by a bar code included in the scanned image data (step S106). When plural bar codes are included in the scanned image data, the control unit 210 acquires plural pieces of information corresponding to the respective bar codes. Then, the control unit 210 determines whether or not a process is executable using the acquired information. When the control unit determines that a process is executable, the process is executed based on the acquired information (step S107). Details of each process will be described later.

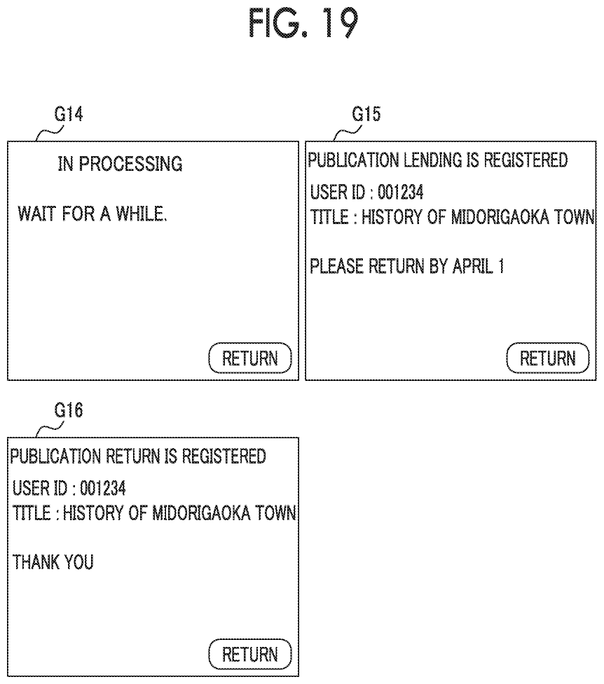

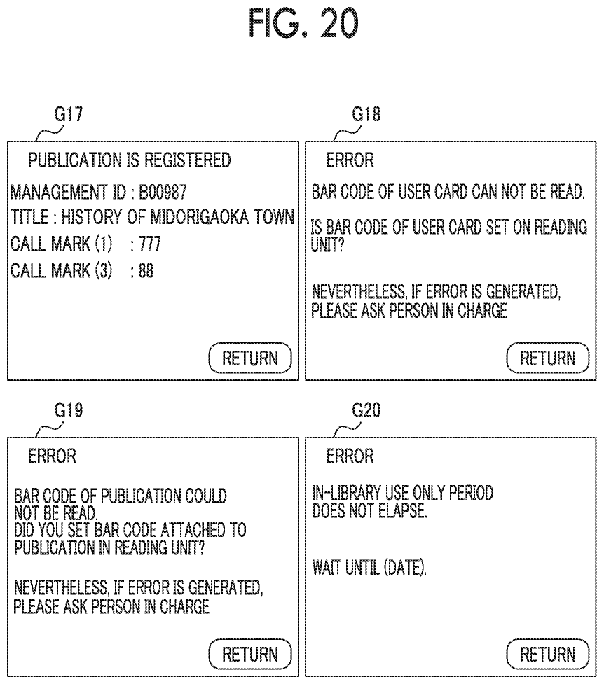

During step S105 to step S107, the control unit 101 of the image processing apparatus 100 designates a URL designated using the transition destination screen designation information and requests a state display screen from the server device 200. When the process of step S107 has not been completed (step S109; NO), the control unit 210 of the server device 200 transmits screen data in progress (a screen G14 in progress of FIG. 19) to the image processing apparatus 100 (step S108 and step S110). In addition, the control unit 210 transmits normally terminated screen data (process result screens G15 and G16 of FIG. 19 and a process result screen G17 of FIG. 20) to the image processing apparatus 100 when the process of step S107 is normally terminated (step S109; YES) and transmits an error screen (process result screens G18, G19, and G20 of FIG. 20) to the image processing apparatus when the process of step S107 is erroneously terminated (step S111).

E-2: Registration Function

Next, the process of step S107 (FIG. 15) at the time of registering a publication will be described with reference to FIG. 16. After scanning is performed by reading one or plural publications placed on the platen of the image reading unit 104 of the image processing apparatus 100, the control unit 210 of the server device 200 decodes one or plural bar codes which are included in the scanned image data acquired from the image processing apparatus 100, and acquires one or plural pieces of information which are specified from the respective bar codes. It is determined whether or not the pieces of information include a character string indicating an ISBN (step S301). When various types of information such as an ISBN, an ISSN, a user ID, and management numbers of a book and a magazine are identified, a discrimination method using the respective prefixes is considered. Specifically, the setting is made such that the ISBN is a 13-digit numerical value starting with 987, the ISSN is a 13-digit numerical value starting with 977, the user ID starts with a specific prefix such as, for example, A (for example, A0012345), the management number of the book starts with a specific prefix such as, for example, YB (for example, YB00012), and the management number of the magazine starts with a specific prefix such as, for example, YM (for example, YM0002222), and the control unit 210 determines the type of information using the prefixes. In addition, the number of digits of each piece of information and a so-called check digit may be used. In addition, the discrimination may be performed using the type of bar code, or may be performed using an image of the vicinity of the bar code (a guide image and the like) and the position of the bar code.

When an ISBN is obtained (step S301; YES), the control unit 210 designates the ISBN to inquire bibliographic information with respect to the bibliographic information storage device 300 (step S302). When the bibliographic information is obtained, the control unit 210 gives a management number (step S303). The control unit 210 specifies a call number (1) corresponding to a book classification code included in the acquired bibliographic information with reference to the classification table 223 (step S304). Next, the control unit 210 specifies a call number (3) with respect to the specified call number (1) (step S305). The control unit 210 adds a new record to the book DB 221 and registers necessary information (step S306). The control unit 210 prints the management bar code 11 of the management number by using the image forming unit 103 based on the registered information (step S307). The control unit 210 prints a label including the call number (1) and the call number (3) by using the image forming unit 103 (step S308). The created management bar code and label are attached to the book.

On the other hand, when an ISSN is obtained (step S301; NO and step S309; YES), the control unit 210 designates the ISSN to inquire bibliographic information with respect to the bibliographic information storage device 300 (step S310). When the bibliographic information is obtained, the control unit 210 gives a management number (step S311). The control unit 210 adds a new record to the magazine DB 222 and registers necessary information (step S312). The control unit 210 prints the management bar code 11 of the management number by using the image forming unit 103 (step S313). The control unit 210 prints the in-library use only label 12 by using the image forming unit 103 (step S314). The created management bar code and the in-library use only label 12 are attached to the magazine.

Meanwhile, a printing timing of the management bar code 11 of step S307 or step S313 does not particularly matter. For example, after the information of step S306 or step S312 is registered, data of the management bar code may be created and printed later.

Meanwhile, when an ISBN and an ISSN are not acquired (step S301; NO and step S309; NO), the control unit 210 determines that publication registration is disabled and instructs the image processing apparatus 100 to display an error (step S315). In other words, the determinations of step S301 and step S309 are equivalent to determination regarding whether or not publication registration, which is a requested process, may be performed. In this case, the front cover and the back cover of a publication are read by the image processing apparatus 100 to be subjected to optical character recognition (OCR), and may be used as bibliographic information.

The registration function may include a function of deleting information on a publication registered in a database. In this case, the control unit 210 of the server device 200 decodes one or plural bar codes included in scanned image data to acquire one or plural pieces of information. The control unit 210 determines whether or not a character string indicating a management number is included in the information. When the management number is obtained, the control unit 210 deletes information corresponding to the management number in the book DB 221 in a case of a book referring to the management number and deletes information corresponding to the management number in the magazine DB 222 in a case of a magazine referring to the management number.

E-3: Lending Function

Next, a process of step S107 (FIG. 15) at the time of lending a publication will be described with reference to FIG. 17.

After scanning is performed by reading one or plural publications and the user card 4 which are placed on the platen of the image reading unit 104 of the image processing apparatus 100, the control unit 210 of the server device 200 decodes one or plural bar codes included in scanned image data acquired from the image processing apparatus 100 to acquire one or plural pieces of information. The control unit 210 determines whether or not a character string indicating a user ID is included in the information (step S200). When the user ID is obtained (step S200; YES), the control unit 210 collates the user ID with a user ID included in a user DB stored in the storage unit 220 and determines whether or not the user is a proper user (step S201). When it is determined that the user is a proper user (step S201; YES), the control unit 210 determines whether or not a character string indicating a management number is included in the information (step S202). When the management number is obtained (step S202; YES), the control unit 210 determines whether or not it is a book with reference to the management number (step S203). In a case of a book (step S203; YES), the control unit 210 reads outs the book DB 221 (step S204) and updates a lending flag, a user ID, and a lending date to the contents of lending (step S205).

On the other hand, when the control unit 210 determines a magazine with reference to the management number (step S203; NO and step S206; YES), the control unit reads out the magazine DB 222 (step S207) and updates a lending flag, a user ID, and a lending date for the management number to the contents of non-lending (step S209) if an in-library use only period has not passed (step S208; YES). Meanwhile, when a user ID and a management number are not acquired (step S201; NO or step S202; NO), the control unit 210 determines that the publication lending is disabled and instructs the image processing apparatus 100 to display an error (step S210). In other words, the determinations of step S201 and step S209 are equivalent to determination regarding whether or not publication lending, which is a requested process, may be performed.

E-4: Return Function

With regard to the return of a book and a magazine, a lending flag, a user ID, and a lending date for a management number may be updated to the contents corresponding to return by the same procedure as at the time of lending.

E-5: Literature Copying Function

The literature copying function is realized using the copying function of the image processing apparatus 100. The image processing apparatus 100 provides the literature copying function to a user for a fee, and thus the image processing apparatus realizes a function of managing charging a user in addition to the copying function. For this reason, the image processing apparatus 100 includes a charge management device having a usage fee input port, an accommodation space for inserted money, and the like, on the inner side or on the outer side thereof.

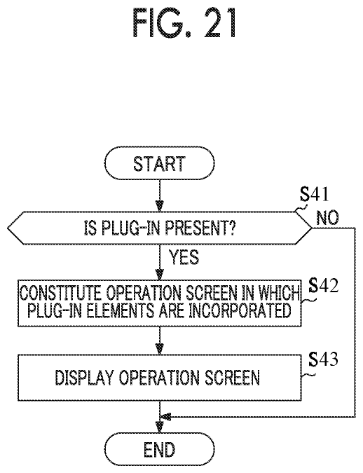

When a user selects the menu item Ma4, corresponding to the literature copying function, which is included in the book menu screen Ga, the control unit 101 of the image processing apparatus 100 executes a command associated with the menu item Ma4 and performs operations illustrated in FIG. 21. FIG. 21 is a flow chart illustrating operations regarding the literature copying function performed by the image processing apparatus 100.

First, the control unit 101 determines whether or not a plug-in related to the literature copying function is present (step S41). The plug-in of this exemplary embodiment is a plug-in that expands a copying function as a standard function. The plug-in includes information of a method of incorporating a menu item, and specifically includes display data (for example, information of a display element, a label, an icon, and a display position) and a calling function (a mathematical function, a URL, and the like). In addition, the display data may include information for replacing a display element (for example, a title) in the standard function.

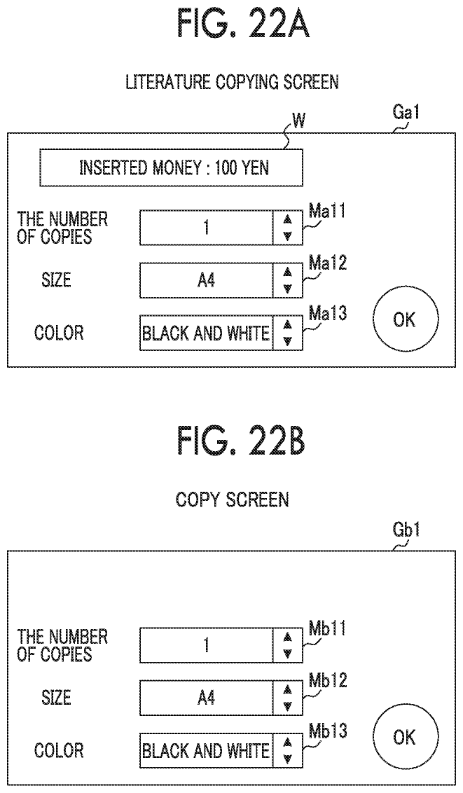

When determining the plug-in is present (step S41; Yes), the control unit 101 incorporates elements of the plug-in into an operation screen of the copying function to thereby constitute an operation screen of a literature copying function (step S42). Herein, the control unit 101 executes “Libcopy_coinkit.zip” as a plug-in to thereby constitute an operation screen of a literature copying function. The control unit 101 displays the constituted operation screen on the UI unit 106 (step S43). FIG. 22A is a diagram illustrating a literature copying screen Ga1 indicating an operation screen of a literature copying function. As illustrated in FIG. 22A, the literature copying screen Ga1 includes a menu item Ma11 for designating the number of copies, a menu item Ma12 for designating the size of a copy paper, and a menu item Ma13 for designating a color to be used for copying. The menu items Ma11 to Ma13 are shared by a menu item Mb11 for designating the number of copies, a menu item Mb12 for designating the size of a copy paper, and a menu item Mb13 for designating a color to be used for copying, the menu items being included in a copy screen Gb1 indicating an operation screen of a copying function illustrated in FIG. 22B.

The control unit 101 displays a window W (widget) indicating a usage fee for a literature copying function which is inserted by a user, on the literature copying screen Ga1. In addition, the control unit 101 confirms the amount of money which is inserted by the user, and determines whether the amount of money reaches a specified usage fee. That is, when the literature copying function is called, the control unit 101 calls a copying function and expands a copying function by a plug-in. When an OK button of the literature copying screen Ga1 is selected by a user, the control unit 101 performs control for copying a publication by performing the same process as in a case of realizing the copying function.

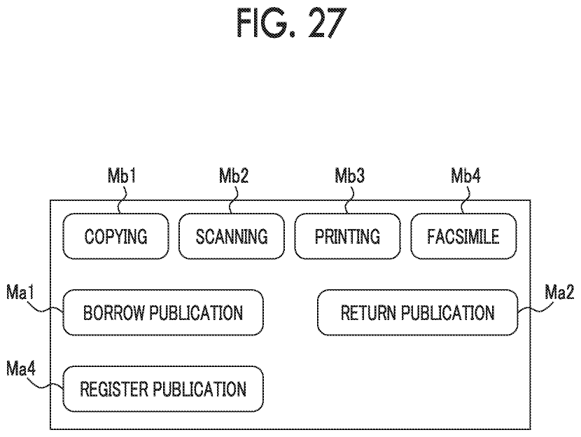

According to the first exemplary embodiment described above, the number of menu items disposed in one screen is reduced as compared with a case where the menu items Ma1, Ma2, and Ma4 corresponding to additional functions in a menu screen including the menu items Mb1 to Mb4 corresponding to standard functions are displayed, for example, as illustrated in FIG. 27. Further, in this exemplary embodiment, the menu screen is divided into the menu items corresponding to the standard functions and the menu items corresponding to the additional functions. For this reason, a user provided with an additional function of the image processing apparatus 100 may perform an operation of selecting a menu item included in the book menu screen Ga displayed on the top screen, and a user provided with a standard function of the image processing apparatus 100 may cause the standard function menu screen Gb to be displayed and may perform an operation of selecting a menu item. Therefore, according to the image processing apparatus 100, individual users of an additional function and a standard function easily operate a menu item, and particularly a user of an additional function easily operates a menu item. In addition, there is a low possibility of an erroneous operation occurring in which a user of an additional function erroneously selects a menu item corresponding to a standard function.

In addition, the image processing apparatus 100 realizes an additional function by calling a standard function thereof, and further expands the standard function to be capable of executing various processes regarding the additional function by using the standard function.

### Second Exemplary Embodiment

In the image processing apparatus 100 of the first exemplary embodiment described above, a menu screen is divided into an additional function and a standard function which are related to book management. However, in this exemplary embodiment, a menu screen is divided depending on users provided with functions.

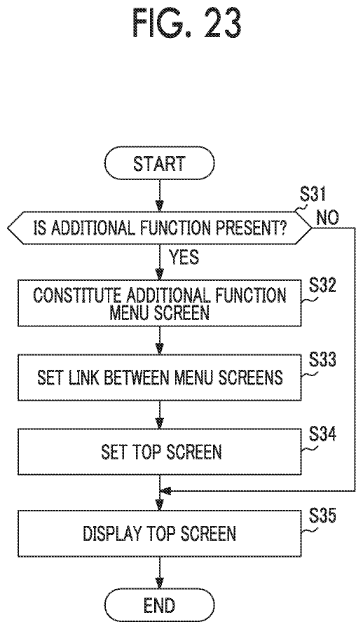

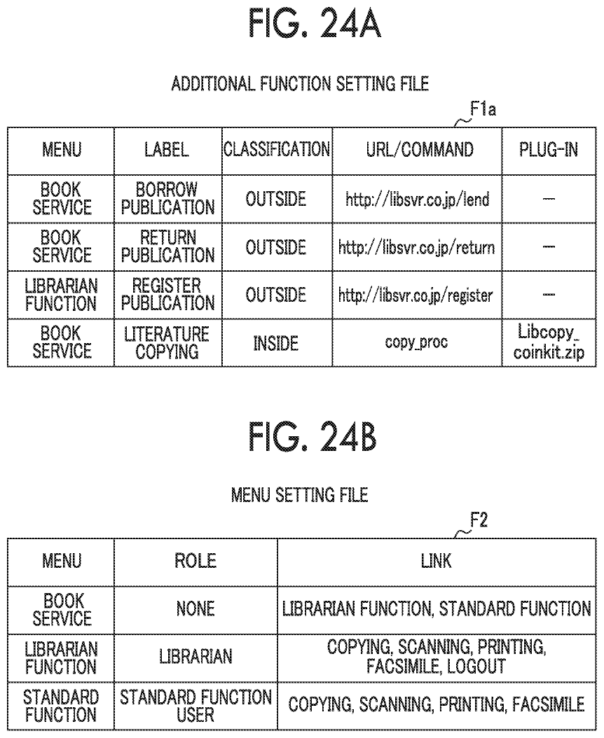

FIG. 23 is a flow chart illustrating the operation of the image processing apparatus 100 after the additional application 102B is installed. First, the control unit 101 determines whether or not an additional function is present, using the same method as step S1 (step S31). When the determination result is “Yes” in step S31, the control unit 101 constitutes an additional function menu screen (step S32). Herein, the control unit 101 constitutes the menu screen by using an additional function setting file and a menu setting file (see FIGS. 24A and 24B) which are acquired based on the additional application 102B.

As illustrated in FIG. 24A, an additional function setting file F1a is a file in which a label, a classification, a URL/command, and a plug-in are associated with a menu item corresponding to an additional function. Herein, the menu item corresponding to the additional function is divided based on attributes of users provided with functions, that is, a “book service” indicating a service regarding a book for general users and a “librarian function” indicating a menu item only for a librarian. The respective pieces of information of the classification, the URL/command, and the plug-in are the same as those in the first exemplary embodiment described above.

As illustrated in FIG. 24B, a role and a link are associated with each menu item in a menu setting file F2. The menu item indicates an attribute of anyone of the book service and the librarian function, which indicate the menu items of the additional function designated in the additional function setting file F1a, and a standard function. The role indicates a role played by a user provided with a function. Herein, the role includes “NONE” (general user) indicating that a role is not particularly designated, a “librarian” who manages publications, and a “standard function user” who uses a standard function. The link indicates a link which is set in a menu screen. Herein, the “librarian function” and the “standard function” are associated with the menu item “book service”. This means that links for transitioning to a menu screen corresponding to the “librarian function” and a menu screen corresponding to the “standard function” are set with respect to a menu screen corresponding to the “book service” for general users. In addition, “copying”, “scanning”, “printing”, “facsimile” and “logout” are associated with the “librarian function”. This means that links for transitioning to screens (for example, operation screens) of copying, scanning, printing, facsimile, and logout are set in the menu screen corresponding to the “librarian function” for a librarian. In addition, “copying”, “scanning”, “printing”, and “facsimile” are associated with the “standard function”. This means that links for transitioning to screens (for example, operation screens) which correspond to the respective functions of copying, scanning, printing, and facsimile are set in the menu screen corresponding to the “standard function” for users of a standard function user.

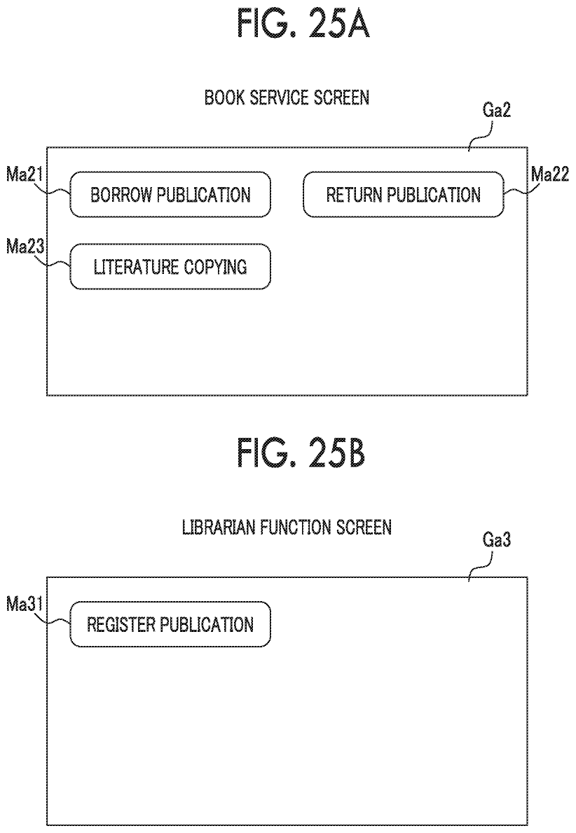

When the additional function setting file F1a and the menu setting file F2 illustrated in FIGS. 24A and 24B are used, a book service screen Ga2 and a librarian function screen Ga3 illustrated in FIGS. 25A and 25B are constituted. As illustrated in FIGS. 25A and 25B, in the book service screen Ga2 (an example of the second menu screen) corresponding to the book service, a menu item Ma21 corresponding to a lending function, a menu item Ma22 corresponding to a return function, and a menu item Ma23 corresponding to a literature copying function are disposed. The menu items Ma21 to Ma23 are the same menu items as the menu items Ma1, Ma2, and Ma3. A menu item Ma31 corresponding to a registration function is disposed in the librarian function screen Ga3 (an example of the second menu screen) which corresponds to a book service for a librarian. The menu item Ma31 is a menu item which is the same as the menu item Ma4.

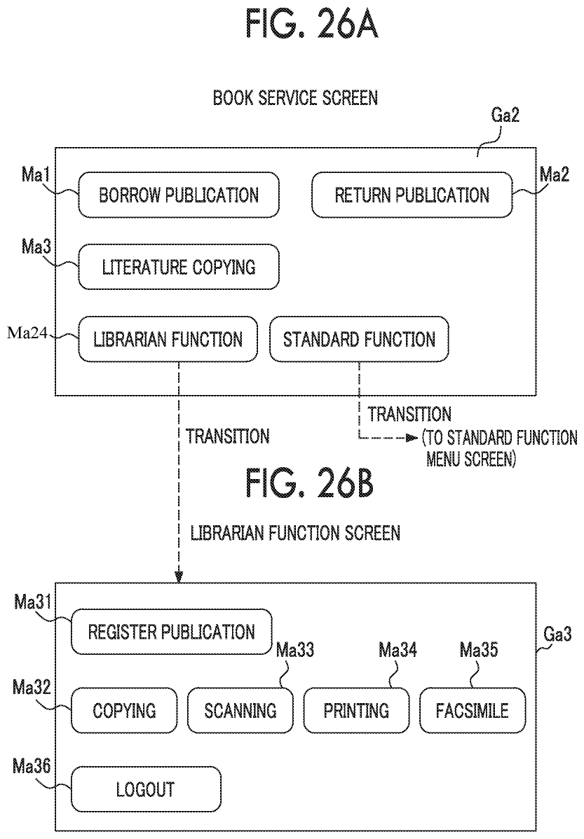

Next, the control unit 101 sets a link between menu screens (step S33). As illustrated in FIGS. 26A and 26B, the control unit 101 disposes a menu item Ma24 associated with a URL for transitioning to the librarian function screen Ga3 and a menu item Ma25 associated with a URL for transitioning to the standard function menu screen Gb in the book service screen Ga2. In addition, the control unit 101 disposes a menu item Ma32 corresponding to a copying function, a menu item Ma33 corresponding to a scanning function, a menu item Ma34 corresponding to a printing function, a menu item Ma35 corresponding to a facsimile function, and a menu item Ma36 for performing a logout, in the librarian function screen Ga3. The menu items Ma32 to Ma35 are the same menu items as the menu items Mb11 to Mb14.

Meanwhile, the authentication screen Gc (see FIG. 8B) is displayed with respect to a librarian function provided to only a librarian, and the librarian function screen Ga3 is displayed after succeeding in the user authentication. In addition, the authentication screen Gc is displayed with respect to a standard function provided to only a standard function user, and the standard function menu screen Gb is displayed after succeeding in the authentication of the standard function user. The standard function menu screen Gb may be the same as the screen described in FIG. 8A.

Next, the control unit 101 sets a top screen, for example, by the procedure described in step S4 and step S5 (for example, step S11 to step S15) in the first exemplary embodiment described above (step S34), and displays the set top screen on the UI unit 106 (step S35). When the top screen is not designated in advance, the control unit 101 sets the book service screen Ga2 which includes a menu item not subjected to user authentication to a top screen to display the book service screen in preference to the librarian function screen Ga3.

According to the second exemplary embodiment described above, the following operational effects are exhibited in addition to the operational effects described in the first exemplary embodiment described above. In the image processing apparatus 100, the book service screen Ga2, which is not subjected to user authentication out of menu items related to book management, is displayed in preference to the librarian function screen Ga3. For this reason, general users who may be present in larger numbers than librarians may easily operate a menu item related to a book service. In the image processing apparatus 100, a menu screen is divided according to a user of each function, and thus each user easily operates a menu item corresponding to a function used by himself or herself.

### Modified Example

The invention may be implemented in a form different from the above-described exemplary embodiments. In addition, the following modified examples may be combined with each other.

(1) In the image processing apparatus 100, a menu screen which is subjected to user authentication may be set to a top screen, instead of a menu screen which is not subjected to user authentication among additional function menu screens. In a case where there are many users to be subjected to authentication such as, for example, a case where the image processing apparatus 100 is installed within an office, it is considered that the setting of a menu screen, which is subjected to user authentication, to a top screen has a tendency to allow many users to easily operate a menu item.

In the image processing apparatus 100, a standard function menu screen may be set to a top screen so that the standard function menu screen is displayed in preference to an additional function menu screen.

(2) According to the above-described exemplary embodiments, in the image processing apparatus 100, an additional function menu screen is set to a top screen and is displayed as an example of “preferential display”. Thus, the additional function menu screen is displayed in preference to the standard function menu screen. However, a mode of the preferential display is not limited to the setting of a top screen. In the image processing apparatus 100, one menu screen to be preferentially displayed may be displayed in preference to the other menu screen, for example, by displaying the menu screen to be preferentially displayed by a smaller number of operations of a user (for example, by reducing the number of operations of an operator) than in the other menu screen. In addition, when the additional function menu screen and the standard function menu screen are disposed in the same hierarchy, one menu screen to be preferentially displayed may be preferentially displayed by being displayed prior to the other menu screen. In this case, when the image processing apparatus 100 receives an operation of moving a display region of one menu screen preferentially displayed during the display of the menu screen such as a flicking operation on the UI unit 106, a display is performed by switching to the other menu screen or other menu screens.

In addition, for example, the image processing apparatus 100 may be configured such that a menu screen to be preferentially displayed may be displayed in preference to one menu screen by prohibiting the one menu screen from being displayed. In addition, when the additional function menu screen is preferentially displayed and the standard function menu screen is prohibited from being displayed, the additional function setting file F1 or F1a may include setting information related to the preferential display of the menu screen.

In the image processing apparatus 100, when one menu screen preferentially displayed is not desired to transition to the other menu screen, a link between menu screens does not need be set as described in step S3 and step S33, and a link between menu screens does not need be displayed. In the image processing apparatus 100, information of user authentication may be used as a condition of whether or not to set and display a link between menu screens. That is, in the image processing apparatus 100, control regarding whether or not to cause an additional function menu screen preferentially displayed to transition to another menu screen is performed according to situations of user authentication. The information of authentication refers to, for example, information on whether or not user authentication succeeds or information on a user who succeeds in authentication (for example, a role played by a user).

In the image processing apparatus 100, an additional function menu screen may be configured to have a larger size than a standard function menu screen, and the menu screens may be simultaneously displayed. In this case, the image processing apparatus 100 may receive an operation of selecting a menu item included in the additional function menu screen. On the other hand, when the image processing apparatus receives an operation of selecting the standard function menu screen, the standard function menu screen may be displayed in a larger size than the additional function menu screen.

That is, in the image processing apparatus 100, a specific method of preferentially displaying a menu screen and a specific operation to be performed by a user in order to change the display of a menu screen do not particularly matter. In addition, methods of displaying a menu screen and a menu item included in the menu screen do not particularly matter.

(3) User authentication is not limited to being performed before displaying a menu screen including a menu item of a function which is subjected to authentication, and may be performed after a menu item of a function which is subjected to authentication is selected.

In addition, the user authentication is not limited to an example of being performed in units of menu items or in units of menu screens, and may be performed in units of plural menu items or in units of plural menu screens. For example, authentication for using a standard function and authentication for using an additional function may be completed through one authentication.

(4) User authentication is not limited to authentication using an ID and a password, and various authentication techniques may be used such as biological authentication, which is performed using an IC card storing user information or using biological information such as a fingerprint, or face authentication performed by capturing an image of a user's face and recognizing a face from the captured image.

(5) In the above-described exemplary embodiments, a process of transmitting an HTTP request to a URL may be performed, for example, in plural parts, and the form of data transmission and reception does not particularly manner.

(6) A portion of the configurations and operations described in the above-described exemplary embodiments may be omitted. For example, the configuration and operation related to the expansion of the standard function, the user authentication, and the like may be omitted.

In addition, the order of the processes performed by the image processing apparatus 100 which are described above with reference to the flow charts may be changed. For example, in step S1 of FIG. 9, when the image processing apparatus 100 determines that an additional function is present (step S1; Yes), the image processing apparatus may perform the processes of step S4 and step S5 to control whether to set the additional function menu screen to a top screen. Then, the image processing apparatus may perform the processes of step S2 and step S3 to constitute the additional function menu screen and set a link between menu screens. In addition, the image processing apparatus 100 may perform the process of step S4 to determine whether to set the additional function menu screen to a top screen. Then, the image processing apparatus may perform the processes of step S2 and step S3 to constitute the additional function menu screen and set a link between menu screens. Thereafter, when the determination result is “Yes” in step S4, the image processing apparatus may set the additional function menu screen to a top screen.

(7) In the above-described exemplary embodiment, the second function of the invention is a function for using the image processing apparatus 100 to manage publications, but is not limited thereto. For example, the invention may be applied to an image processing apparatus to which is added a function of managing data related to work performed in a company or to which is added other functions. The second function of the invention may be a function for using the information processing apparatus for a specific use. The specific use may be a use for crime prevention, a use for attendance/time management, a use for stock management, and the like.

In addition, the second function of the invention is not limited to a function added to the information processing apparatus. The second function of the invention may be, for example, a function which is incorporated in the information processing apparatus in advance. In this case, for example, the information processing apparatus may perform control such that a menu item, corresponding to a specific function, is preferentially displayed among menu items corresponding to plural functions which are incorporated therein in advance. As an example, the image processing apparatus 100 of the above-described exemplary embodiment may include a function for book management as a standard function.

The second function of the invention may be a function added by a program other than an application program.

The first function of the invention is not limited to a copying function, a scanning function, a printing function, or a facsimile function, and may be other functions.

The information processing apparatus of the invention is not limited to an image forming apparatus, and may be an information processing apparatus other than the image forming apparatus, such as a smartphone, a mobile phone, a tablet computer, a notebook computer, or a portable game machine.

(8) The functions realized by the devices (the image processing apparatus 100 and the like) of the information processing system 1000 of the above-described exemplary embodiment may be realized by a combination of plural programs or may be realized in association with plural hardware resources. When the functions of the devices of the information processing system 1000 are realized using a program, the program may be provided in a state where the program is stored in a computer-readable storage medium such as a magnetic recording medium (a magnetic tape, a magnetic disk (hard disk drive (HDD)), a flexible disk (FD), and the like), an optical recording medium (an optical disc and the like), a magneto-optical recording medium, and a semiconductor memory, or may be distributed through a network. In addition, the invention may be understood to be a display control device that realizes a functions equivalent to the UI control unit 130 or as a method of displaying a menu item.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A smartphone comprising:
a display; and
a processor configured to
cause the display to display
(i) a first screen comprising a first item configured to call a first function of the smartphone, the first function requiring an authentication of a user, and
(ii) a second screen that is different from the first screen and comprises a second item configured to call a second function among a plurality of functions of the smartphone, the second function not requiring authentication of the user and being configured to realize a limited version of the first function; and
set whether to display the second screen as a top screen, wherein:
the first screen also comprises another item not included in the second screen,
the processor is further configured to cause the display to display the second screen as the top screen in response to determining that the second screen is set to display as the top screen, and
when the second screen is not set to display as the top screen, the processor is further configured to cause the display to display a third screen as the top screen.

2. The smartphone according to claim 1, wherein
the third screen is an authentication screen.
